(19) United States
(12) Patent Application Publication
(10) Pub. No.: US 2006/0234895 A1
(43) Pub. Date: Oct. 19, 2006

(54) Liquid laundry detergent compositions with modified polyethyleneimine polymers and lipase enzyme

(76) Inventors: Philip frank Souter, Morpeth (GB); John Allen Burdis, Newcastle (GB); Dieter Boeckh, Limburgerhof (DE); Arturo Luis Casado-Dominguez, Brussels (BE); Christian Bittner, Bensheim (DE); Andrea Margret Misske, Speyer (DE)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/403,687

(22) Filed: Apr. 13, 2006

Related U.S. Application Data
(60) Provisional application No. 60/671,588, filed on Apr. 15, 2005.

(51) Int. Cl. C11D 3/48

(52) U.S. Cl. 510/386; 510/426; 510/475

(57) ABSTRACT

A liquid laundry detergent for improved grease and oil cleaning having a lipase enzyme, a modified polyethyleneimine polymer and a liquid carrier.

### CROSS REFERENCE TO RELATED APPLICATION

This application claims benefit of and priority to U.S. Provisional Application Ser. No. 60/671,588, filed Apr. 15, 2005.

### FIELD OF THE INVENTION

The present invention relates to liquid detergent compositions having first wash lipase enzymes and modified polyethyleneimines utilized for improved grease and oil soil cleaning.

### BACKGROUND OF THE INVENTION

Improved removal of greasy soils is a constant aim for laundry detergent manufacturers. In spite of the use of many effective surfactants and combinations of surfactants, especially when used at low water temperatures, many surfactant-based products still do not achieve complete removal of greasy/oily soils. Lipase enzymes have been used in detergents since the late 1980s for removal of fatty soils by breakdown of fatty soils into tri-glycerides.

Until relatively recently, the main commercially available lipase enzymes, such as LIPOLASE® (trade name, Novozymes) worked particularly effectively at the lower moisture levels of the drying phase of the wash process. These enzymes tended to produce significant cleaning only in the second wash step because the active site of the enzyme was occupied by water during the washing process, so that fat breakdown was significant only on soils remaining on laundered clothes during the drying stage, the broken down fats then being removed in the next washing step. However, more recently, higher efficiency lipases have been developed that also work effectively during the wash phase of the cleaning process, so that as well as cleaning in the second washing step, a significant improvement in cleaning effect due to lipase enzyme can be found in the first wash-cycle. Examples of such enzymes are as described in WO00/60063 and Research Disclosure IP6553D. Such enzymes are referred to below as first wash lipases.

The problem facing the present inventors was how to maximize performance from this new generation of enzymes. It has been surprisingly found that the combination of the first wash lipases in combination with modified polyethyleneimine polymers in a liquid detergent composition gives improved grease and oil cleaning results while giving an acceptably stable liquid detergent composition.

Modified polyethyleneimine polymers have been discussed previously as acting as a chlorine scavenger in a detergent composition when combined with the main commercially available lipase enzymes, such as LIPOLASE® in WO 97/4228. However, it has been found that the first wash lipases in combination with the modified polyethyleneiminies defined below in a liquid detergent composition gives improved grease and oil cleaning results verses main commercially available lipase enzymes such as LIPOLASE®.

### SUMMARY OF THE INVENTION

The present invention relates to a liquid laundry detergent composition comprising: (a) from about 5 to about 20000 LU/g of a first wash lipase which is a polypeptide having an amino acid sequence which has at least 90% identity with the wild-type lipase derived from Humicola lanuginosa strain DSM 4109 and compared to said wild-type lipase, comprises a substitution of an electrically neutral or negatively charged amino acid within 15 A of E1 or Q249 with a positively charged amino acid; and may further comprise: (I) a peptide addition at the C-terminal; (II) a peptide addition at the N-terminal; (III) meets the following limitations: (i) comprises a negatively charged amino acid in position E210 of said wild-type lipase; (ii) comprises a negatively charged amino acid in the region corresponding to positions 90-101 of said wild-type lipase; and (iii) comprises a neutral or negatively charged amino acid at a position corresponding to N94 of said wild-type lipase; and/or (iv) has a negative charge or neutral charge in the region corresponding to positions 90-101 of said wild-type lipase; and (IV) mixture thereof; (b) from about 0.01 wt % to about 10 wt % by weight of the composition of a modified polyethyleneimine polymer wherein the modified polyethyleneimine polymer comprises a polyethyleneimine backbone of about 300 to about 10000 weight average molecular weight; the modification of the polyethyleneimine backbone is: (1) one or two alkoxylation modifications per nitrogen atom in the polyethyleneimine backbone, the alkoxylation modification consisting of the replacement of a hydrogen atom by a polyalkoxylene chain having an average of about 1 to about 40 alkoxy moieties per modification, wherein the terminal alkoxy moiety of the alkoxylation modification is capped with hydrogen, a C₁-C₄ alkyl or mixtures thereof; (2) a substitution of one C₁-C₄ alkyl moiety and one or two alkoxylation modifications per nitrogen atom in the polyethyleneimine backbone, the alkoxylation modification consisting of the replacement of a hydrogen atom by a polyalkoxylene chain having an average of about 1 to about 40 alkoxy moieties per modification wherein the terminal alkoxy moiety is capped with hydrogen, a C₁-C₄ alkyl or mixtures thereof; or (3) a combination thereof; and (c) the balance of the composition comprising a liquid carrier.

The present invention further relates to a method of removing soils and stains and a method of making a liquid laundry detergent composition

### DETAILED DESCRIPTION OF THE INVENTION

It has been surprisingly found that the combination of the first wash lipases in combination with modified polyethyleneimines for a liquid detergent composition gives improved grease and oil cleaning results.

As used herein “first wash lipase” means higher efficiency lipases developed that work effectively during the wash phase of a cleaning process, so that as well as cleaning in the second washing step, a significant improvement in cleaning effect due to lipase enzyme can be found in the first wash-cycle. Examples of such enzymes are as described in WO00/60063 and Research Disclosure IP6553D.

Incorporated and included herein, as if expressly written herein, are all ranges of numbers when written in a “from X to Y” or “from about X to about Y” or “X-Y” format. It should be understood that every limit given throughout this specification will include every lower or higher limit, as the case may be, as if such lower or higher limit was expressly written herein. Every range given throughout this specification will include every narrower range that falls within such broader range, as if such narrower ranges were all expressly written herein.

Unless otherwise indicated, weight percentage is in reference to weight percentage of the composition. All temperatures, unless otherwise indicated are in Celsius.

First Wash Lipase Enzyme

The preferred first wash lipase enzymes for use in the present liquid detergent composition are described in WO00/60063, WO 99/42566, WO 02/062973, WO 97/04078, WO 97/04079 and U.S. Pat. No. 5,869,438, the most preferred being a first wash lipase sold under the tradename LIPEX® (registered tradename of Novozymes), a variant of the Humicola lanuginosa (Thermomyces lanuginosus) lipase (LIPOLASE® registered tradename of Novozymes) with the mutations T231R and N233R.

The first wash lipase enzyme incorporated into the detergent compositions of the present invention is generally present in an amount of 5 to 20000 LU/g of the detergent composition, or even 35 to 5000 LU/g. The LU unit for lipase activity is defined in WO99/42566. The lipase dosage in the wash solution is typically from 0.005 to 5 mg/l active lipase protein, more typically from 0.01 to 0.5 mg/l as enzyme protein.

The first wash lipase of interest in the present detergent composition is a polypeptide having an amino acid sequence which has at least 90% identity with the wild-type lipase derived from Humicola lanuginosa strain DSM 4109 and compared to said wild-type lipase, comprises a substitution of an electrically neutral or negatively charged amino acid within 15 A of E1 or Q249 with a positively charged amino acid; and may further comprise: (a) a peptide addition at the C-terminal; (b) a peptide addition at the N-terminal; (c) meets the following limitations: (i) comprises a negatively charged amino acid in position E210 of said wild-type lipase; (ii) comprises a negatively charged amino acid in the region corresponding to positions 90-101 of said wild-type lipase; (iii) comprises a electrically neutral or negatively charged amino acid at a position corresponding to N94 of said wild-type lipase; and/or (iv) has a negative or neutral net electric charge in the region corresponding to positions 90-101 of said wild-type lipase; and (d) mixture thereof.

Humicola lanuginosa Lipase

The reference lipase used in this composition is the wild-type lipase derived from Humicola lanuginosa strain DSM 4109. It is described in EP 258 068 and EP 305 216 and has the amino acid sequence shown in positions 1-269 of SEQ ID NO: 2 of U.S. Pat. No. 5,869,438. In this specification, the reference lipase is also referred to as LIPOLASE®.

Substitution with Positive Amino Acid

The lipase of the invention comprises one or more (e.g. 2-4, particularly two) substitutions of an electrically neutral or negatively charged amino acid near E1 or Q249 with a positively charged amino acid, preferably R. The substitution is at the surface of the three-dimensional structure within 15 A of E1 or Q249, e.g. at any of positions 1-11, 90, 95, 169, 171-175, 192-211, 213-226, 228-258, 260-262. The substitution may be within 10 A of E1 or Q249, e.g. at any of positions 1-7, 10, 175, 195, 197-202, 204-206, 209, 215, 219-224, 230-239, 242-254. The substitution may be within 15 A of E1, e.g. at any of positions 1-11, 169, 171, 192-199, 217-225, 228-240, 243-247, 249, 261-262. The substitution is most preferably within 10 A of E1, e.g. at any of positions 1-7, 10, 219-224 and 230-239. Thus, some preferred substitutions are S3R, S224R, P229R, T231 R, N233R, D234R and T244R.

Peptide Addition at C-Terminal

The lipase may comprise a peptide addition attached to C-terminal L269. The peptide addition preferably consists of 1-5 amino acids, e.g. 2, 3 or 4 amino acids. The amino acids of the peptide addition will be numbered 270, 271, etc. The peptide addition may consist of electrically neutral (e.g. hydrophobic) amino acids, e.g. PGL or PG. In an alternative embodiment, the lipase peptide lo addition consists of neutral (e.g. hydrophobic) amino acids and the amino acid C, and the lipase comprises substitution of an amino acid with C at a suitable location so as to form a disulfide bridge with the C of the peptide addition. Examples are: 270C linked to G23C or T37C 271 C linked to K24C, T37C, N26C or R81 C 272C linked to D27C, T35C, E56C, T64C or R81 C. Amino acids at positions 90-101 and 210.

The lipase of the invention preferably meets certain limitations on electrically charged amino acids at positions 90-101 and 210. Thus, amino acid 210 may be negatively charged. E210 may be unchanged or it may have the substitution E210D/CN, particularly E210D. The lipase may comprise a negatively charged amino acid at any of positions 90-101 (particularly 94-101), e.g. at position D96 and/or E99. Further, the lipase may comprise an electrically neutral or negatively charged amino acid at position N94, i.e. N94 (neutral or negative), e.g. N94N/D/E.

Also, the lipase may have a negative or neutral net electric charge in the region 90-101 (particularly 94-101), i.e. the number of negatively charged amino acids is equal to or greater than the number of positively charged amino acids. Thus, the region may be unchanged from LIPOLASE®, having two negatively charged amino acids (D96 and E99) and one positively charged amino acid (K98), and having an electrically neutral amino acid at position 94 (N94), or the region may be modified by one or more substitutions.

Alternatively, two of the three amino acids N94, N96 and E99 may have a negative or unchanged electric charge. Thus, all three amino acids may be unchanged or may be changed by a conservative or negative substitution, i.e. N94 (neutral or negative), D (negative) and E99 (negative). Examples are N94D/E and D96E. Also, one of the three may be substituted so as to increase the electric charge, i.e. N94 (positive), D96 (neutral or positive) or E99 (neutral or positive). Examples are N94K/R, D961/UN/S/W or E99N/Q/K/R/H.

Peptide Extension at N-Terminal

The lipase of the invention comprises a positively charged peptide extension attached to the N-terminal. The peptide extension preferably consists of 1-15 (particularly 4-10) amino acid residues, and preferably comprises 1, 2 or 3 positively charged amino acids, most preferably 1, 2 or 3 R. Optionally, the electric charge at the N-terminal may be further increased by substituting E1 with an electrically neutral or positively charged amino acid, e.g. E1 P. Some preferred peptide extensions are SPIRR, RP(-E), SPIRPRP(-E), SPPRRP(-E) and SPIRPRID(-E).

The peptide extension may comprise C (cysteine) attached by a disulfide bridge to a second C in the polypeptide (either C present in Lipolase or introduced by a substitution), e.g. SPPCGRRP(-E), SPCRPR, SPCRPRP(-E), SPPCGRRPRRP(-E), SPPNGSCGRRP(-E), SPPCRRRP(-E) or SCIRR attached to E239C. Further, any peptide extension described in WO 97104079 and WO 97107202 may be used.

Amino Acid Grouping

As discussed, amino acids are classified as negatively charged, positively charged or electrically neutral according to their electric charge at pH 10. Thus, negative amino acids are E, D, C (cysteine) and Y, particularly E and D. Positive amino acids are R, K and H, particularly R and K. Neutral amino acids are G, A, V, L, 1, P, F, W, S, T M, N, Q and C when forming part of a disulfide bridge. A substitution with another amino acid in the same group (negative, positive or neutral) is termed a conservative substitution. The electrically neutral amino acids may be divided into hydrophobic (G, A, V, L, 1, P, F, W and C as part of a disulfide bridge) and hydrophilic (S, T M, N, Q).

Amino Acid Identity

The lipase variant of the present composition has an amino acid identity of at least 90% (preferably more than 95% or more than 98%) with LIPOLASE®. The degree of identity may be suitably determined by means of computer programs known in the art, such as GAP provided in the GCG program package (Program Manual for the Wisconsin Package, Version 8, August 1994, Genetics Computer Group, 575 Science Drive, Madison, Wis., USA 53711) (Needleman, S. B. and Wunsch, C. D., (1970), Journal of Molecular Biology, 48, 443-45), using GAP with the following settings for polypeptide sequence comparison: GAP creation penalty of 3.0 and GAP extension penalty of 0.1.

The first wash lipase enzyme may be incorporated into the detergent composition in any convenient form, generally in the form of a non-dusting granulate, a stabilized liquid or a coated enzyme particle.

Modified Polyethyleneimine Polymer

The present composition comprises from about 0.01 wt % to about 10 wt %, preferably from about 0.1 wt % to about 5 wt %, more preferable from about 0.3% to about 3% by weight of the composition of a modified polyethyleneimine polymer.

The modified polyethyleneimine polymer of the present composition has a polyethyleneimine backbone having a molecular weight from about 300 to about 10000 weight average molecular weight, preferably from about 400 to about 7500 weight average molecular weight, preferably about 500 to about 1900 weight average molecular weight and preferably from about 3000 to 6000 weight average molecular weight.

The modification of the polyethyleneimine backbone includes: (1) one or two alkoxylation modifications per nitrogen atom, dependent on whether the modification occurs at a internal nitrogen atom or at an terminal nitrogen atom, in the polyethyleneimine backbone, the alkoxylation modification consisting of the replacement of a hydrogen atom on by a polyalkoxylene chain having an average of about 1 to about 40 alkoxy moieties per modification, wherein the terminal alkoxy moiety of the alkoxylation modification is capped with hydrogen, a C₁-C₄ alkyl or mixtures thereof; (2) a substitution of one C₁-C₄ alkyl moiety and one or two alkoxylation modifications per nitrogen atom, dependent on whether the substitution occurs at a internal nitrogen atom or at an terminal nitrogen atom, in the polyethyleneimine backbone, the alkoxylation modification consisting of the replacement of a hydrogen atom by a polyalkoxylene chain having an average of about 1 to about 40 alkoxy moieties per modification wherein the terminal alkoxy moiety is capped with hydrogen, a C₁-C₄ alkyl or mixtures thereof; or (3) a combination thereof.

For example, but not limited to, below is shown possible modifications to terminal nitrogen atoms in the polyethyleneimine backbone where R represents an ethylene spacer and E represents a C₁-C₄ alkyl moiety and X- represents a suitable water soluble counterion.

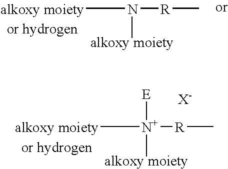

Also, for example, but not limited to, below is shown possible modifications to internal nitrogen atoms in the polyethyleneimine backbone where R represents an ethylene spacer and E represents a C₁-C₄ alkyl moiety and X− represents a suitable water soluble counterion.

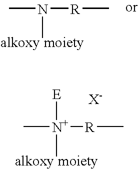

The alkoxylation modification of the polyethyleneimine backbone consists of the replacement of a hydrogen atom by a polyalkoxylene chain having an average of about 1 to about 40 alkoxy moieties, preferably from about 5 to about 20 alkoxy moieties. The alkoxy moieties are selected from ethoxy (EO), 1,2-propoxy (1,2-PO), 1,3-propoxy (1,3-PO), butoxy (BO), and combinations thereof. Preferably, the polyalkoxylene chain is selected from ethoxy moieties and ethoxy/propoxy block moieties. More preferably, the polyalkoxylene chain is ethoxy moieties in an average degree of from about 5 to about 15 and the polyalkoxylene chain is ethoxy/propoxy block moieties having an average degree of ethoxylation from about 5 to about 15 and an average degree of propoxylation from about 1 to about 16. Most preferable the polyalkoxylene chain is is the ethoxy/propoxy block moieties wherein the propoxy moiety block is the terminal alkoxy moiety block.

The modification may result in permanent quaternization of the polyethyleneimine backbone nitrogen atoms. The degree of permanent quaternization may be from 0% to about 30% of the polyethyleneimine backbone nitrogen atoms. It is preferred to have less than 30% of the polyethyleneimine backbone nitrogen atoms permanently quaternized.

A preferred modified polyethyleneimine has the general structure of formula (I): 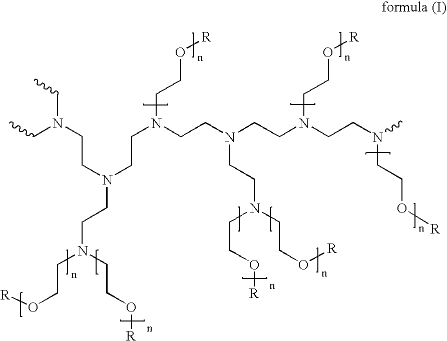
wherein the polyethyleneimine backbone has a weight average molecular weight of 5000, n of formula (I) has an average of 7 and R of formula (I) is selected from hydrogen, a C₁-C₄ alkyl and mixtures thereof.

Another preferred polyethyleneimine has the general structure of formula (II): 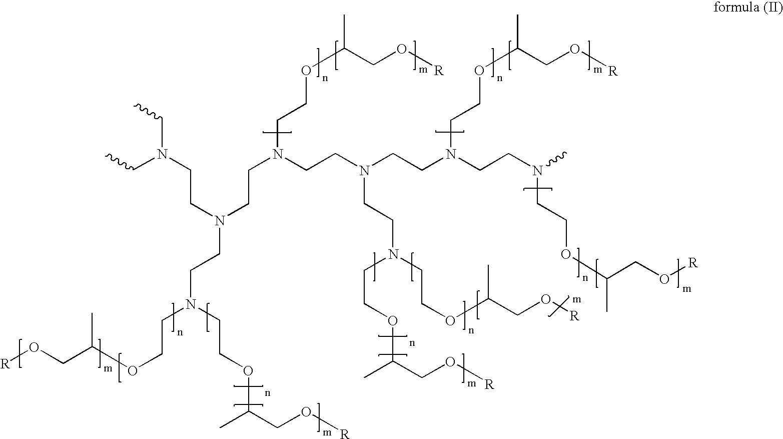
wherein the polyethyleneimine backbone has a weight average molecular weight of 5000, n of formula (II) has an average of 10, m of formula (II) has an average of 7 and R of formula (II) is selected from hydrogen, a C₁-C₄ alkyl and mixtures thereof. The degree of permanent quaternization of formula (II) may be from 0% to about 22% of the polyethyleneimine backbone nitrogen atoms.

Yet another preferred polyethyleneimine has the same general structure of formula (II) where the polyethyleneimine backbone has a weight average molecular weight of 600, n of formula (II) has an average of 10, m of formula (II) has an average of 7 and R of formula (II) is selected from hydrogen, a C₁-C₄ alkyl and mixtures thereof. The degree of permanent quaternization of formula (II) may be from 0% to about 22% of the polyethyleneimine backbone nitrogen atoms.

These polyethyleneimines can be prepared, for example, by polymerizing ethyleneimine in the presence of a catalyst such as carbon dioxide, sodium bisulfite, sulfuric acid, hydrogen peroxide, hydrochloric acid, acetic acid, and the like. Specific methods for preparing these polyamine backbones are disclosed in U.S. Pat. No. 2,182,306, Ulrich et al., issued Dec. 5, 1939; U.S. Pat. No. 3,033,746, Mayle et al., issued May 8, 1962; U.S. Pat. No. 2,208,095, Esselmann et al., issued Jul. 16, 1940; U.S. Pat. No. 2,806,839, Crowther, issued Sep. 17, 1957; and U.S. Pat. No. 2,553,696, Wilson, issued May 21, 1951.

### EXAMPLE 1

### Polyethyleneimine of Molecular Weight 5000 (Hereinafter PEI5000) Modified with 7 Ethoxy Moieties (EO) per Nitrogen-Hydrogen Bond (NH)

a) Treatment of PEI5000 with 1 EO/NH

Heat to 80° C. in a 2 L reactor 900 g of a 50 wt % aqueous solution of PEI5000 (backbone molecular weight 5000) and strip with nitrogen thrice (until a pressure of 500 kPa (5 bar) is obtained). Increase the temperature to 90° C. and add 461 g ethylene oxide until pressure rises to 500 kPa (5 bar). Remove the volatile components after 2 hours by stripping with nitrogen at 80° C. or vacuum of 50 kPa (500 mbar) at 80° C. Collect 1345 g of a 68% aqueous solution, which contains PEI5000 with 1 EO/NH

b) Alkoxylation of PEI5000 with 1 EO/NH in the Presence of a Solvent

Treat in a 2 l reactor 362 g of a 68.5% aqueous solution from step (a) with 31 g of 40% aqueous solution of potassium hydroxide and 300 g xylene and and strip with nitrogen thrice (until a pressure of 500 kPa (5 bar) is obtained). Remove water during a 4 hour time period at 170° C. (under ascription of solvent). Add 753 g ethylene oxide at 120° C. until pressure of 300 kPa (3 bar) is obtained. Stir for 3 hours at 120° C. Remove the solvent from the compound and strip with a water steam at 120° C. for 3 hours. Collect 1000 g of a bright brownish viscous liquid (amine: 2.5448 mmol/g; pH value at 1% weight in water 11.2), which is the desired product PEI5000 with 7 EO/NH.

### EXAMPLE 2

### Polyethyleneimine of Molecular Weight 5000 Modified with 10 Ethoxy Moieties (EO) and 7 Propoxy Moieties (PO) per Nitrogen-Hydrogen Bond (NH)

a) Treatment of PEI5000 with 1 EO/NH as in Example 1.

b) Alkoxylation of PEI5000 with 1 EO/NH

Treat in a 2 l reactor 163 g of a 68.4% the aqueous solution from step (a) with 13.9 g of 40% an aqueous solution of potassium hydroxide, heat to 70° C. and strip with nitrogen thrice (until a pressure of 500 kPa (5 bar) is obtained). Remove water during a 4 hour time period at 120° C. and vacuum of 1 kPa (10 mbar). Add 506 g ethylene oxide at 120° C. until pressure of 800 kPa (8 bar) is obtained. Stir for 4 hours at 120° C. Strip with nitrogent 120° C. Add 519 g propylene oxide at 120° C. until pressure of 800 kPa (8 bar) is obtained. Stir for 4 hours at 102° C. Remove volatile components by stripping with nitrogen at 80° C. or vacuum of 50 kPa (500 mbar) at 80° C. Collect 1178 g of a bright brownish viscous liquid (amine titer: 0.9276 mmol/g; pH value at 1% weight in water 10.67), which is the desired product PEI5000 with 10 EO and 7 PO/NH.

OR

Alternative b) Alkoxylation of PEI5000 with 1 EO/NH in the presence of a solvent Treat in a 2 l reactor 137 g of a 68.7% the aqueous solution from (a) with 11.8 g of 40% aqueous solution of potassium hydroxide and 300 g xylene and strip with nitrogen thrice (until pressure of 500 kPa (5 bar)). Remove the water present over the next 4 hours while maintaining a temperature of 170° C. (under ascription of solvent). Add 428 g of ethylene oxide at 120° C. until pressure of 300 kPa (3 bar) is obtained and stir for 2 hours at 120° C. Strip with nitrogen at 120° C. Add 439 g propylene oxide at 120° C. until pressure of 300 kPa (3 bar) is obtained. Stir for 3 hours at 120° C. Remove the solvent from the compound and strip with a water steam at 120° C. for 3 hours. Collect 956 g of a bright brownish viscous liquid (amine titer: 0.9672 mmol/g; pH value at 1% weight in water 10.69), which is the desired product PEI5000 with 10 EO and 7 PO/NH.

### EXAMPLE 3

### Polyethyleneimine of Molecular Weight 5000 Modified with 9.9 Ethoxy Moieties (EO) and 3.5 Propoxy Moieties (PO) per Nitrogen-Hydrogen (NH) Bond

a) Treatment of PEI5000 with 1 EO/NH as in Example 1.

b) Alkoxylation of PEI5000 with 1 EO/NH

Treat in a 2 L reactor 321 g of a 69.2% aqueous solution from (a) with 28 g of 40% aqueous solution of potassium hydroxide, heat to 80° C. and strip with nitrogen thrice (until pressure of 500 kPa (5 bar) is obtained). Remove water during the next 3 hours while maintaining a temperature of 120° C. and vacuum of 1 kPa (10 mbar). Add 1020 g ethylene oxide at 120° C. until pressure of 800 kPa (8 bar) is obtained. Stir for 4 hours at 120° C. Remove the volatile components by stripping with nitrogen at 80° C. or under a vacuum of 50 kPa (500 mbar) at 80° C. Collect 1240 g of a brownish viscous liquid, which contains PEI 5000 with 9.9 EO/NH (amine titer: 1.7763 mmol/g; pH value at 1% weight in water 11.3). Strip with nitrogen (until pressure of 500 kPa (5 bar) is obtained) 239 g of PEI 5000 with 9.9 EO/NH and heat to 120° C. Add 87 g (metering precision +/−15 g) propylene oxide at 120° C. until pressure of 800 kPa (8 bar) is obtained. Stir for 4 hours at 120° C. Remove volatile components by stripping with nitrogen at 80° C. or under a vacuum of 50 kPa (500 mbar) at 80° C. Collect 340 g of a bright brownish viscous liquid (amine titer: 1.2199 mmol/g; pH value at 1% weight in water 11.05), which is the desired product PEI5000 with 9.9 EO and 3.5 PO/NH.

### EXAMPLE 4

### Polyethyleneimine of Molecular Weight 5000 Modified with 9.9 Ethoxy Moieties (EO) and 15.5 Propoxy Moieties (PO) per Nitrogen-Hyddrogen Bond (NH)

a) Treatment of PEI5000 with 1 EO/NH as in Example 1

b) Alkoxylation of PEI5000 with 1 EO/NH

Treat in a 2 L reactor 321 g of a 69.2% aqueous solution from (a) with 28 g of 40% aqueous solution of potassium hydroxide, heat to 80° C. and strip with nitrogen thrice (until a pressure of 500 kPa (5 bar) is obtained). Remove water during the next 3 hours while maintaining a temperature of 120° C. and vacuum of 1 kPa (10 mbar). Add 1020 g ethylene oxide at 120° C. until pressure of 800 kPa (8 bar) is obtained. Stir for 4 hours at 120° C. Remove the volatile components by stripping with nitrogen at 80° C. or under a vacuum of 50 kPa (500 mbar) at 80° C. Collect 1240 g of a brownish viscous liquid, which contains PEI 5000 with 9.9 EO/NH (amine titer: 1.7763 mmol/g; pH value at 1% weight in water 11.3). Strip with nitrogen (until pressure of 500 kPa (5 bar) is obtained) 156 g of PEI 5000 with 9.9 EO/NH were heated to 120° C. Add 284 g (metering precision +/−15 g) propylene oxide at 120° C. until pressure of 800 kPa (8 bar) is obtained. Stir for 4 hours at 120° C. Remove volatile components by stripping with nitrogen at 80° C. or under a vacuum of 50 kPa (500 mbar) at 80° C. Collect 450 g of a bright brownish viscous liquid (amine titer: 0.6545 mmol/g; pH value at 1% weight in water 11.05), which is the desired product PEI5000 with 9.9 EO and 15.5 PO/NH.

Surfactant System

The composition of the present invention comprises a surfactant system comprising C₁₀-C₁₈ alkyl ethoxy sulfates (AEₓS) wherein x is from about 1 to about 30, preferably is from about 1 to about 10; more preferably from about 1 to about 5. The alkyl ethoxy sulfate surfactant may be present in the composition from about 5% to about 30%; or from about 7% to 16% by weight of the composition.

The surfactant system may further comprise from 0% to about 7%; or from about 0.1% to about 5%; or from about 1% to about 4% by weight of the composition of a co-surfactant selected from a nonionic co-surfactant, anionic co-surfactant and any mixture thereof.

Nonionic Co-Surfactants

Non-limiting examples of nonionic co-surfactants include: C₁₂-C₁₈ alkyl ethoxylates, such as, NEODOL® nonionic surfactants from Shell and LUTENSOL® XL and LUTENSOL® XP from BASF; C₆-C₁₂ alkyl phenol alkoxylates wherein the alkoxylate units are a mixture of ethoxy and propoxy units; C₁₂-C₁₈ alcohol and C₆-C₁₂ alkyl phenol condensates with ethylene oxide/propylene oxide block alkyl polyamine ethoxylates such as PLURONIC® from BASF; C₁₄-C₂₂ mid-chain branched alcohols, BA, as discussed in U.S. Pat. No. 6,150,322; C₁₄-C₂₂ mid-chain branched alkyl alkoxylates, BAEₓ, wherein x is from 1-30, as discussed in U.S. Pat. No. 6,153,577, U.S. Pat. No. 6,020,303 and U.S. Pat. No. 6,093,856; Alkylpolysaccharides as discussed in U.S. Pat. No. 4,565,647 Llenado, issued Jan. 26, 1986; specifically alkylpolyglycosides as discussed in U.S. Pat. No. 4,483,780 and U.S. Pat. No. 4,483,779; Polyhydroxy fatty acid amides as discussed in U.S. Pat. No. 5,332,528; and ether capped poly(oxyalkylated) alcohol surfactants as discussed in U.S. Pat. No. 6,482,994 and WO 01/42408.

Non-limiting examples of semi-polar nonionic co-surfactants include: water-soluble amine oxides containing one alkyl moiety of from about 10 to about 18 carbon atoms and 2 moieties selected from the group consisting of alkyl moieties and hydroxyalkyl moieties containing from about 1 to about 3 carbon atoms; water-soluble phosphine oxides containing one alkyl moiety of from about 10 to about 18 carbon atoms and 2 moieties selected from the group consisting of alkyl moieties and hydroxyalkyl moieties containing from about 1 to about 3 carbon atoms; and water-soluble sulfoxides containing one alkyl moiety of from about 10 to about 18 carbon atoms and a moiety selected from the group consisting of alkyl moieties and hydroxyalkyl moieties of from about 1 to about 3 carbon atoms. See WO 01/32816, U.S. Pat. No. 4,681,704, and U.S. Pat. No. 4,133,779.

Anionic Co-Surfactants

Nonlimiting examples of anionic co-surfactants useful herein include: C₁₀-C₂₀ primary, branched chain and random alkyl sulfates (AS); C₁₀-C₁₈ secondary (2,3) alkyl sulfates; C₁₀-C₁₅ alkyl benzene sulfonates (LAS); C₁₀-C₁₈ alkyl alkoxy carboxylates comprising 1-5 ethoxy units; mid-chain branched alkyl sulfates as discussed in U.S. Pat. No. 6,020,303 and U.S. Pat. No. 6,060,443; mid-chain branched alkyl alkoxy sulfates as discussed in U.S. Pat. No. 6,008,181 and U.S. Pat. No. 6,020,303; modified alkylbenzene sulfonate (MLAS) as discussed in WO 99/05243, WO 99/05242 and WO 99/05244; methyl ester sulfonate (MES); and alpha-olefin sulfonate (AOS).

In one embodiment, the co-surfactant is selected as a C₁₂₋₁₈ linear alkyl sulphate in such an amount that the mass ratio of AEₓ S to C₁₂₋₁₈ linear alkyl sulphate is larger than 2 (>2:1), preferably larger than 2.8 (>2.8:1), more preferably larger than 3.3 (>3.3:1).

Liquid Carrier

The liquid detergent compositions according to the present invention also contain a liquid carrier. Generally the amount of the liquid carrier employed in the compositions herein will be relatively large, often comprising the balance of the detergent composition, but can comprise from about 20 wt % to about 85 wt % by weight of the detergent composition. Preferably, the compositions of the present invention comprise from about 40% to about 80% of an aqueous liquid carrier.

The most cost effective type of aqueous, non-surface active liquid carrier is, of course, water itself. Accordingly, the aqueous, non-surface active liquid carrier component will generally be mostly, if not completely, comprised of water. While other types of water-miscible liquids, such C₁-C₃ lower alkanols such as methanol, ethanol and/or propanol, diols, other polyols, ethers, C₁-C₃ alkanolamines such as mono-, di- and triethanolamines, and the like, have been conventionally been added to liquid detergent compositions as hydrotropes, co-solvents or stabilizers. If utilized, phase stabilizers/co-solvents can comprise from about 0.1% to 5.0% by weight of the compositions herein.

Soil Suspending Agents, Soil Release Agents

The liquid detergent compositions of the present invention may further comprise a polymer system having soil suspending agents, soil release agents, and mixtures thereof. Soil suspending agents may be those commonly known in the art such as block polyesters according to U.S. Pat. No. 4,702,857 Gosselink, issued Oct. 27, 1987 and sulfonated linear terephthalate ester oligomers according to U.S. Pat. No. 4,968,451, Scheibel et al., issued Nov. 6, 1990.

Soil release agents may be those commonly known in the art such as ethoxylated tetraethylene pentaimine (EO₁₅₋₁₈) according to U.S. Pat. No. 4,597,898 Vander Meer, issued Jul. 1, 1986, and ethoxylated hexamethylene diamine available under the tradename LUTENSIT® from BASF and such as those described in WO 01/05874.

The soil suspending agents and soil release agents may comprise from about 0.1% to about 2% by weight of the liquid detergent composition.

Optional Components

The detergent compositions of the present invention can also include any number of additional optional ingredients. These include conventional laundry detergent composition components such as detersive builders, enzymes, enzyme stabilizers (such as propylene glycol, boric acid and/or borax), suds suppressors, other fabric care benefit agents, pH adjusting agents, chelating agents, smectite clays, structuring agents, dye transfer inhibiting agents, optical brighteners, perfumes and coloring agents. The various optional detergent composition ingredients, if present in the compositions herein, should be utilized at concentrations conventionally employed to bring about their desired contribution to the detergent composition or the laundering operation. Frequently, the total amount of such optional detergent composition ingredients can range from about 5% to about 50%, more preferably from about 5% to about 40%, by weight of the composition.

Additional Enzymes

Additional enzymes can be included in effective amounts in the liquid laundry detergent composition herein for a wide variety of fabric laundering purposes, including removal of protein-based, carbohydrate-based, or triglyceride-based stains, for example, and/or for fabric restoration. As used herein, an “effective amount” is an amount of additional enzyme to achieve the desired removal of a stain or amount of fabric restoration.

Examples of suitable enzymes include, but are not limited to, hemicellulases, peroxidases, proteases, cellulases, xylanases, lipases other than those described above, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and known amylases, or combinations thereof. Other types of enzymes may also be included. They may be of any suitable origin, such as vegetable, animal, bacterial, fungal and yeast origin. However, their choice is governed by several factors such as pH-activity and/or stability optima, thermostability, stability versus active detergents, builders and so on.

A potential enzyme combination comprises a cocktail of conventional detersive enzymes like protease, lipase, cutinase and/or cellulase in conjunction with amylase. Detersive enzymes are described in greater detail in U.S. Pat. No. 6,579,839. Particularly preferred compositions herein contain from about 0.05% to about 2% by weight of detersive enzymes.

Additional enzymes are normally incorporated at levels sufficient to provide up to about 5 mg by weight, more typically about 0.01 mg to about 3 mg, of active enzyme per gram of the composition. Stated otherwise, the compositions herein will typically comprise from about 0.001% to about 5%, preferably 0.01% to 1% by weight of a commercial enzyme preparation. Protease enzymes are usually present in such commercial preparations at levels sufficient to provide from 0.005 to 0.1 Anson units (AU) of activity per gram of composition.

Proteases useful herein include those like subtilisins from Bacillus [e.g. subtilis, lentus, licheniformis, amyloliquefaciens (BPN, BPN′), alcalophilus,] e.g. ESPERASE®, ALCALASE®, EVERLASE® and SAVINASE® (Novozymes), BLAP and variants (Henkel). Further proteases are described in EP130756, WO91/06637, WO95/10591 and WO99/20726.

Amylases (α and/or β) are described in WO 94/02597 and WO 96/23873. Commercial examples are PURAFECT OX AM® (Genencor) and TERMAMYL®, NATALASE®, BAN®, FUNGAMYL® and DURAMYL® (all ex Novozymes). Amylases also include, for example, α-amylases described in British Patent Specification No. 1,296,839 (Novozymes), and RAPIDASE® (International Bio-Synthetics, Inc).

The cellulases usable in the present composition include either bacterial or fungal cellulase. Preferably, they will have a pH optimum of between 5 and 9.5. Suitable cellulases are disclosed in U.S. Pat. No. 4,435,307, Barbesgoard et al, issued Mar. 6, 1984. Cellulases useful herein include bacterial or fungal cellulases, e.g. produced by Humicola insolens, particularly DSM 1800, e.g. 50 Kda and ^{˜}43 kD (CAREZYME®). Also suitable cellulases are the EGIII cellulases from Trichoderma longibrachiatum.

Other suitable lipases not described above include those produced by Pseudomonas and Chromobacter groups. The LIPOLASE® enzyme derived from Humicola lanuginosa and commercially available from Novozymes (see also EPO 41,947) is a suitable lipase for use herein. Also suitable are e.g., LIPOLASE ULTRA® and LIPOPRIME® from Novozymes. Also suitable are cutinases [EC 3.1.1.50] and esterases. See also lipases in Japanese Patent Application 53-020487, laid open to public inspection on Feb. 24, 1978. This lipase is available from Areario Pharmaceutical Co. Ltd., Nagoya, Japan, under the trade name LIPASE P “AMANO®”. Other commercial lipases include AMANO-CES®, lipases ex Chromobacter viscosum, e.g. Chromobacter viscosum var. lipolyticum NRRLB 3673, commercially available from Toyo Jozo Co., Tagata, Japan; and further Chromobacter viscosum lipases from U.S. Biochemical Corp., U.S.A. and Diosynth Co., Netherlands, and other lipases such as Pseudomonas gladioli. Further suitable lipases are described in WO 2004/101759, WO 2004/101760 and WO 2004/101763.

Carbohydrases useful herein include mannanase (e.g., those disclosed in U.S. Pat. No. 6,060,299), pectate lyase (e.g., those disclosed in WO 99/27083), cyclomaltodextringlucanotransferase (e.g., those disclosed in WO 96/33267), xyloglucanase (e.g., those disclosed in WO 99/02663).

Bleaching enzymes useful herein with enhancers include peroxidases, laccases, oxygenases, (e.g., catechol 1,2 dioxygenase), lipoxygenase (e.g., those disclosed in WO 95/26393), and (non-heme) haloperoxidases.

Enzyme materials useful for liquid detergent formulations, and their incorporation into such formulations, are disclosed in U.S. Pat. No. 4,261,868, Hora et al, and in U.S. Pat. No. 4,507,219, Hughes.

Enzyme Stabilizer

If an enzyme or enzymes are included in the compositions of the present invention, it is preferred that the composition also contain an enzyme stabilizer. Enzymes can be stabilized using any known stabilizer system like calcium and/or magnesium compounds, boron compounds and substituted boric acids, aromatic borate esters, peptides and peptide derivatives, polyols, low molecular weight carboxylates, relatively hydrophobic organic compounds (i.e., certain esters, diakyl glycol ethers, alcohols or alcohol alkoxylates), alkyl ether carboxylate in addition to a calcium ion source, benzamidine hypochlorite, lower aliphatic alcohols and carboxylic acids, N,N-bis(carboxymethyl) serine salts; (meth)acrylic acid-(meth)acrylic acid ester copolymer and PEG; lignin compounds, polyamide oligomer, glycolic acid or its salts; poly hexa methylene bi guanide or N,N-bis-3-amino-propyl-dodecyl amine or salt; and mixtures thereof. See also U.S. Pat. No. 3,600,319, Gedge, et al., EP 0 199 405 A, Venegas, U.S. Pat. No. 3,519,570 and U.S. Pat. No. 4,537,706 (borate species).

Typical detergents, especially liquids, will comprise from about 1 to about 30, preferably from about 2 to about 20, more preferably from about 5 to about 15, and most preferably from about 8 to about 12, millimoles of calcium ion per liter of finished composition to provide enzyme stability. Any water-soluble calcium or magnesium salt can be used as the source of calcium or magnesium ions, including, but not limited to, calcium chloride, calcium sulfate, calcium malate, calcium maleate, calcium hydroxide, calcium formate, and calcium acetate, and the corresponding magnesium salts. Accordingly, as a general proposition the compositions herein will typically comprise from about 0.05% to about 2% by weight of the detergent composition of a water-soluble source of calcium or magnesium ions, or both.

In a liquid composition, the degradation by the proteolytic enzyme of second enzymes can be avoided by protease reversible inhibitors such as peptide or protein type, in particular the modified subtilisin inhibitor of family VI and the plasminostrepin; leupeptin, peptide trifluoromethyl ketones, peptide aldehydes.

Organic Detergent Builders

The detergent compositions herein may also optionally contain an organic detergent builder material. Examples include the alkali metal, citrates, succinates, malonates, carboxymethyl succinates, carboxylates, polycarboxylates and polyacetyl carboxylates. Specific examples include sodium, potassium and lithium salts of oxydisuccinic acid, mellitic acid, benzene polycarboxylic acids, C₁₀-C₂₂ fatty acids and citric acid. Other examples are DEQUEST® organic phosphonate type sequestering agents sold by Monsanto and alkanehydroxy phosphonates. Citrate salts and C₁₂-C₁₈ fatty acid soaps are highly preferred.

Other suitable organic builders include the higher molecular weight polymers and copolymers known to have builder properties. For example, such materials include appropriate polyacrylic acid, polymaleic acid, and polyacrylic/polymaleic acid copolymers and their salts, such as those sold by BASF under the SOKALAN® trademark.

If utilized, the composition may comprise up to 30%, preferably from about 1% to about 20%, more preferably from abut 3% to about 10%, by weight of the composition, of the organic builder materials.

pH Control Agents

The detergent compositions herein may also optionally contain low levels of materials which serve to adjust or maintain the pH of the detergent compositions herein at optimum levels. The pH of the compositions herein should range from about 7.8 to 8.5, more preferably from about 8.0 to 8.5. Materials such as NaOH can be added to alter composition pH, if necessary.

Composition Form, Preparation and Use

The liquid detergent compositions herein are in the form of an aqueous solution or uniform dispersion or suspension of surfactant, opacifying agent and certain optional other ingredients, some of which may normally be in solid form, that have been combined with the normally liquid components of the composition such as the aqueous liquid carrier, and any other normally liquid optional ingredients.

The aqueous liquid detergent compositions herein can be prepared by combining the components thereof in any convenient order and by mixing, e.g., agitating, the resulting component combination to form the phase stable liquid detergent compositions herein. In a preferred process for preparing such compositions, components will be combined in a particular order. In such a preferred preparation process, a liquid matrix is formed containing at least a major proportion, and preferably substantially all, of the liquid components, e.g., the surfactant, the non-surface active liquid carriers and other optional liquid components with the liquid components being thoroughly admixed by imparting shear agitation to this liquid combination. For example, rapid stirring with a mechanical stirrer may usefully be employed.

While shear agitation is maintained, substantially all of the surfactants and the solid form ingredients can be added. Agitation of the mixture is continued, and if necessary, can be increased at this point to form a solution or a uniform dispersion of insoluble solid phase particulates within the liquid phase.

After some or all of the solid-form materials have been added to this agitated mixture, the particles of the preferred enzyme material, e.g., enzyme prills, are incorporated. Thus the enzyme component is preferably added to the aqueous liquid matrix last.

As a variation of the composition preparation procedure hereinbefore described, one or more of the solid components may be added to the agitated mixture as a solution or slurry of particles premixed with a minor portion of one or more of the liquid components.

After addition of all of the composition components, agitation of the mixture is continued for a period of time sufficient to form compositions having desired viscosity and phase stability characteristics (viscosity of about 100-700 cps, more preferably from about 200 to about 500 cps, and stable for long periods of time such as 7-240 days). Frequently this will involve agitation for a period of from about 30 to 60 minutes.

The compositions of this invention, prepared as hereinbefore described, can be used directly onto fabrics or used to form aqueous washing solutions for use in the laundering of fabrics. Generally, an effective amount of such compositions is added directly to the fabric or directly to water, preferably in a conventional fabric laundering automatic washing machine, to form such aqueous laundering solutions. As used herein “effective amount” refers to an amount providing the desired cleaning benefits of greasy soils and oily soils. The aqueous washing solution so formed is then contacted, preferably under agitation, with the fabrics to be laundered therewith.

An effective amount of the liquid detergent compositions herein added fabric is from 0.5 mL to 10 mL of the composition. An effective amount of the liquid detergent composition herein added to water to form aqueous laundering solutions can comprise amounts sufficient to form from about 500 to 7,000 ppm of composition in aqueous washing solution. More preferably, from about 1,000 to 3,000 ppm of the detergent compositions herein will be provided in aqueous washing solution.

The present liquid detergent composition may also be utilized in a method of removing soils and stains from a surface comprising the steps of: (a) pretreating the soils and stains with the liquid detergent compositions of the present invention to form a pretreated surface; (b) adding an effective amount of the liquid detergent compositions of the present invention to water to form from an aqueous washing solution comprising about 500 to about 7000 ppm of the composition; (c) contacting the aqueous washing solution with the pretreated surface, and (d) optionally providing agitation to the aqueous washing solution and the pretreated surface. The pretreated surface is preferably fabric.

The liquid detergent compositions herein may be provided in a multiple use bottle or may be provided to consumers in a number of unit dose packages. Unit dose packages useful herein include those known in the art and include those that are water soluble, water insoluble, water permeable, and mixtures thereof.

TABLE 1
Formulations

| | A | B | C | D | E | F |
|---|---|---|---|---|---|---|
| | (wt %) | (wt %) | (wt %) | (wt %) | (wt %) | (wt %) |
| C₁₂₋₁₅ alkyl ethoxy (1.8) sulfate | 11 | 12.65 | 8.25 | 6.32 | 11.0 | 8.2 |
| Sodium formate | 1.6 | 0.09 | 1.2 | 0.04 | 1.6 | 1.2 |
| Sodium hydroxide | 2.3 | 3.8 | 1.7 | 1.9 | 2.3 | 1.7 |
| monoethanolamine | 1.4 | 1.490 | 1.0 | 0.7 | 1.35 | 1.0 |
| Diethylene glycol | 5.5 | 0.0 | 4.1 | 0.0 | 5.500 | 4.1 |
| C₁₂₋₁₃ ethoxylated (9) alcohol | 0.4 | 0.6 | 0.3 | 0.3 | 0.4 | 0.3 |
| diethylene triamine penta | 0.15 | 0.15 | 0.11 | 0.07 | 0.15 | 0.11 |
| acetate MW = 393 | | | | | | |
| C₁₁₋₁₂ linear alkyl | 4 | 6.6 | 3.0 | 3.3 | 4.0 | 3.0 |
| benzene sulfonate | | | | | | |
| Citric Acid | 2.5 | 3.96 | 1.88 | 1.98 | 2.5 | 1.88 |
| C₁₂₋₁₄ dimethyl | 0.3 | 0.73 | 0.23 | 0.37 | 0.3 | 0.225 |
| Amine Oxide | | | | | | |
| C₁₂₋₁₈ Fatty Acid | 0.8 | 1.9 | 0.6 | 0.99 | 0.8 | 0.6 |
| Borax | 1.43 | 1.5 | 1. | 0.75 | 1.43 | 1.07 |
| Ethanol | 1.54 | 1.77 | 1.15 | 0.89 | 1.54 | 1.15 |
| ethoxylated (EO₁₅) | 0.3 | 0.33 | 0.23 | 0.17 | 0.0 | 0.0 |
| tetraethylene | | | | | | |
| pentaimine¹ | | | | | | |
| Polyethyleneimine | 0.65 | 0.65 | 0.49 | 0.32 | 0.0 | 0.0 |
| (backbone Mw | | | | | | |
| 1600) with | | | | | | |
| ethoxylation | | | | | | |
| (EO₂₀)² | | | | | | |
| ethoxylated | 0.8 | 0.81 | 0.6 | 0.4 | 0.0 | 0.0 |
| hexamethylene | | | | | | |
| diamine³ | | | | | | |
| Polymer⁴ | 1 | 1 | 1 | 1 | 1 | 1 |
| 1,2-Propanediol | 0.0 | 6.6 | 0.0 | 3.3 | 0.0 | 0.0 |
| Protease* | 36.4 | 36.4 | 27.3 | 18.2 | 36.4 | 27.3 |
| Mannaway* | 1.1 | 1.1 | 0.8 | 0.6 | 1.1 | 0.8 |
| Natalase* | 7.3 | 7.3 | 5.5 | 3.7 | 7.3 | 5.5 |
| Lipase⁵* | 3.2 | 3.2 | 3.2 | 3.2 | 3.2 | 3.2 |
| Water, perfume, | Balance | Balance | Balance | Balance | Balance | Balance |
| dyes & other components | | | | | | |

*Numbers quoted in mg enzyme/100 g
¹as described in U.S. Pat. No. 4,597,898.
²as described in U.S. Pat. No. 5,565,145.
³available under the tradename LUTENSIT ® from BASF and such as those described in WO 01/05874
⁴as described in formula (I) and (II)
⁵available under the tradename LIPEX ® from Novozymes

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid laundry detergent composition comprising:
(a) from about 5 to about 20000 LU/g of a first wash lipase which is a polypeptide having an amino acid sequence which has at least 90% identity with the wild-type lipase derived from Humicola lanuginosa strain DSM 4109 and compared to said wild-type lipase, comprises a substitution of an electrically neutral or negatively charged amino acid within 15 A of E1 or Q249 with a positively charged amino acid; and may further comprise:
(I) a peptide addition at the C-terminal;
(II) a peptide addition at the N-terminal;
(III) meets the following limitations:
i) comprises a negatively charged amino acid in position E210 of said wild-type lipase;
ii) comprises a negatively charged amino acid in the region corresponding to positions 90-101 of said wild-type lipase; and
iii) comprises a neutral or negatively charged amino acid at a position corresponding to N94 of said wild-type lipase; and/or
iv) has a negative charge or neutral charge in the region corresponding to positions 90-101 of said wild-type lipase; and
(IV) mixture thereof;
(b) from about 0.01 wt % to about 10 wt % by weight of the composition of a modified polyethyleneimine polymer wherein the modified polyethyleneimine polymer comprises a polyethyleneimine backbone of about 300 to about 10000 weight average molecular weight; the modification of the polyethyleneimine backbone is:
(1) one or two alkoxylation modifications per nitrogen atom in the polyethyleneimine backbone, the alkoxylation modification comprising the replacement of a hydrogen atom by a polyalkoxylene chain having an average of about 1 to about 40 alkoxy moieties per modification, wherein the terminal alkoxy moiety of the alkoxylation modification is capped with hydrogen, a C₁-C₄ alkyl or mixtures thereof;
(2) a substitution of one C₁-C₄ alkyl moiety and one or two alkoxylation modifications per nitrogen atom in the polyethyleneimine backbone, the alkoxylation modification comprising the replacement of a hydrogen atom by a polyalkoxylene chain having an average of about 1 to about 40 alkoxy moieties per modification wherein the terminal alkoxy moiety is capped with hydrogen, a C₁-C₄ alkyl or mixtures thereof; or
(3) a combination thereof; and
(c) the balance of the composition comprising a liquid carrier.

2. The liquid laundry detergent composition of claim 1 wherein the lipase is a polypeptide having an amino acid sequence which further comprises (I), (II) and (IV) mixtures thereof.

3. The liquid laundry detergent composition of claim 1 wherein the modified polyethyleneimine polymer comprises a polyethyleneimine backbone of about 400 to about 7500 weight average molecular weight; the modification of the polyethyleneimine backbone comprises the replacement of a hydrogen atom by a polyalkoxylene chain comprising ethoxy/propoxy block moieties wherein the propoxy moiety block is the terminal alkoxy moiety block, having from about 5 to about 15 ethoxy moieties and from about 1 to about 16 propoxy moieties; wherein the terminal alkoxy moiety blocks are capped with hydrogen, a C₁-C₄ alkyl or mixtures thereof.

4. The liquid laundry detergent composition of claim 1 wherein the composition further comprises (d) a surfactant system comprising from about 5% to about 30% by weight of the composition of a C₁₀-C₁₈ alkyl ethoxy sulfate having an average degree of ethoxylation is from about 1 to about 30 and from about 1 wt % to about 10 wt % by weight of the composition of an anionic co-surfactant.

5. The liquid laundry detergent composition of claim 1 wherein the composition further comprises from about 0.05 wt % to about 2 wt % by weight of the composition an enzyme stabilization system.

6. The liquid laundry detergent composition of claim 1 wherein the composition further comprises from about 1 wt % to about 20 wt % by weight of the composition of an organic detergent builder.

7. The liquid laundry detergent composition of claim 1 wherein the composition further comprises an effective amount of additional enzymes selected from hemicellulases, peroxidases, proteases, cellulases, xylanases, lipases other (a), phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or combinations thereof.

8. The liquid laundry detergent composition of claim 1 wherein the modified polyethyleneimine polymer is selected as: 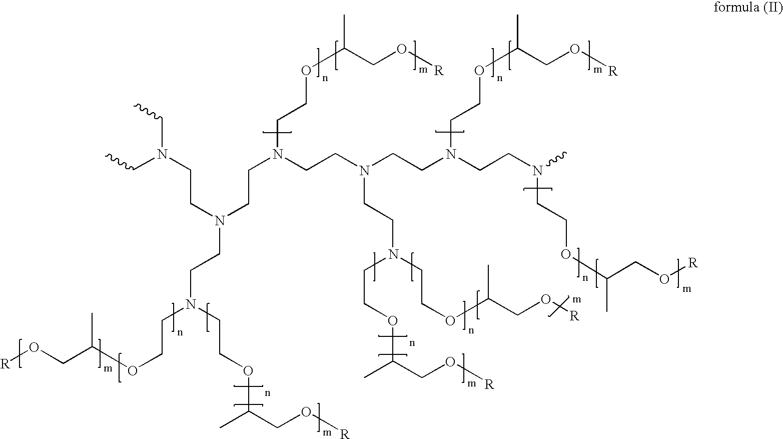
wherein the polyethyleneimine backbone of formula (II) has a weight average molecular weight of 600 or 5000, n of formula (II) has an average of 10, m of formula (II) has an average of 7 and R of formula (II) is selected from hydrogen, a C₁-C₄ alkyl and mixtures thereof; and the degree of permanent quaternization of formula (II) is from 0% to about 22% of the polyethyleneimine backbone nitrogen atoms.

9. A method of removing soils and stains from a surface comprising the steps of:
(a) optionally pretreating the soils and stains with the compositions of claim 1 to form an optionally pretreated surface;
(b) adding an effective amount of the compositions of claim 1 to water to form from an aqueous washing solution comprising about 500 to about 7000 ppm of the composition;
(c) contacting the aqueous washing solution with the optionally pretreated surface, and
(d) optionally providing agitation to the aqueous washing solution and the optionally pretreated surface.

10. A method of making a liquid laundry detergent composition comprising the steps of:
(a) forming a liquid matrix containing the surfactant system, the liquid carriers being thoroughly admixed by imparting shear agitation to for a liquid phase;
(b) adding any desired solid form ingredients, except for a enzyme component, to form a mixture;
(c) agitating the mixture to form a solution or a uniform dispersion of insoluble solid phase particulates within the liquid phase; and
(d) adding a enzyme component to the solution or uniform dispersion to form the composition.
